(19) United States
(12) Patent Application Publication
(10) Pub. No.: US 2026/0017106 A1
(43) Pub. Date: Jan. 15, 2026

(54) DATA SERVICE DISTRIBUTION BASED ON ENERGY EFFICIENCY

(71) Applicant: RED HAT, INC., Raleigh, NC (US)

(72) Inventors: Leigh Griffin, Waterford (IE); James Mernin, Waterford (IE)

(21) Appl. No.: 18/772,764

(22) Filed: Jul. 15, 2024

(51) Int. Cl. G06F 9/50

(52) U.S. Cl. CPC G06F 9/5033

(57) ABSTRACT

Some examples of the present disclosure relate to data service distribution based on energy efficiency. In one particular example, a system can receive a request to instantiate a service on a node of a plurality of nodes. The system can determine a usage metric associated with the service using a resource of the node, an energy metric associated with energy usage of the service, and a plurality of node capabilities for the plurality of nodes. The system can determine, based on the usage metric, the energy metric, and the plurality of node capabilities, scores associated with deploying the service on each node of the plurality of nodes. The system can deploy the service on a first node of the plurality of nodes based on a first score associated with the first node being higher than a second score associated with a second node of the plurality of nodes.

### TECHNICAL FIELD

The present disclosure relates generally to software execution. More specifically, but not by way of limitation, this disclosure relates to distributing workloads based on node properties.

### BACKGROUND

Distributed computing systems (e.g., cloud computing systems, data grids, and computing clusters) have recently grown in popularity given their ability to improve flexibility, responsiveness, and speed over conventional computing systems. In some cases, the responsiveness and speed of distributed computing systems can be further improved by employing edge-computing solutions. Edge computing is a networking philosophy focused on bringing computing power and data storage as close to the source of the data as possible to reduce latency and bandwidth usage. Distributed computing environments may employ edge devices to perform various functions at the edge. Edge devices may be resource constrained and geographically isolated.

### BRIEF DESCRIPTION OF THE DRAWINGS

FIG. 1 is a block diagram of an example of a system for data service distribution based on energy efficiency according to some examples of the present disclosure.

FIG. 2 is a block diagram of an example of a computing environment for data service distribution based on energy efficiency according to some examples of the present disclosure.

FIG. 3 is a flow chart of an example of a process for data service distribution based on energy efficiency according to some examples of the present disclosure.

### DETAILED DESCRIPTION

Edge devices may produce vast amounts of data. Since edge devices, such as Internet of Things (IoT) devices, often have limited processing capabilities and constrained resources, edge devices may face challenges related to energy efficiency. In addition, edge devices may experience poor network connectivity, which can lead to additional drain on battery and reduced energy efficiency. Conventional energy management solutions in edge computing focus on optimizing service scheduling, migration, and network communication in order to reduce energy consumption. While these approaches may help conserve energy and while there are some methodologies available that augment them, they lack a standardized method for assessing the energy efficiency of data services, which can limit their effectiveness in selecting the most energy efficient services, leading to reduced overall performance of edge devices.

Some examples of the present disclosure can overcome one or more of the abovementioned problems by providing a system that can distribute services based on energy efficiency. The system can receive a request to instantiate a service on a node of a plurality of nodes. The system can determine a usage metric associated with the service using a resource of the node, an energy metric associated with energy usage of the service, and a plurality of node capabilities for the plurality of nodes. The system can determine, based on the usage metric, the energy metric, and the plurality of node capabilities, scores associated with deploying the service on each node of the plurality of nodes. The system can deploy the service on a first node of the plurality of nodes based on a first score associated with the first node being higher than a second score associated with a second node of the plurality of nodes. As a result, the first node may be the most energy efficiency device for executing the service, leading to efficient and improved execution of the service by the first node and reduced energy consumption for the system.

As a particular example, a system can receive a request to instantiate a software application on an edge node of a set of edge nodes. The edge nodes can include a Raspberry Pi and a server. The system can determine that the software application uses fifty Megabytes of random access memory (RAM) and one GigaHertz of central processing unit (CPU). The system can also determine that the software application is expected to consume one hundred Joules of energy irrespective of which node it runs on. In addition, the system determines that the Raspberry Pi has access to a green energy source and is currently not executing any other service, whereas the server only has access to battery power and is executing three services. Based on these factors, the system determines that a score for executing the software application on the Raspberry Pi is higher than a score for executing the software application on the server. The higher score indicates that the Raspberry Pi provides a more energy efficient environment for the deployment of the software application. As such, the system deploys the software application on the Raspberry Pi. Accordingly, the software application is executed on a node that provides higher energy efficiency, resulting in more optimal performance of the edge nodes.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

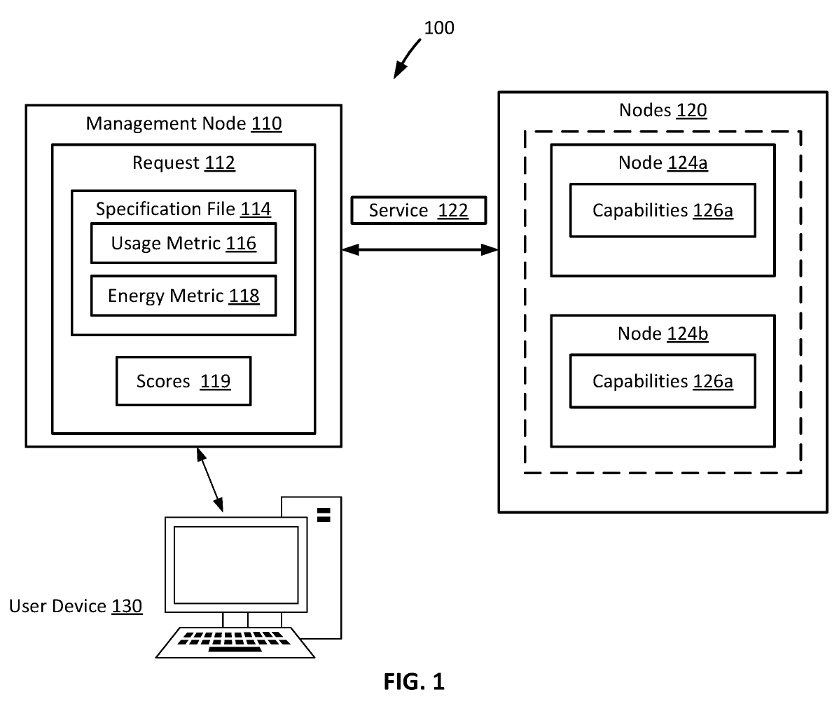

FIG. 1 is a block diagram of an example of a system 100 for data service distribution based on energy efficiency according to some examples of the present disclosure. In some examples, the system 100 may be a distributed computing environment such as an edge computing environment, a cloud computing environment, or a computing cluster. The system 100 can be formed from a management node 110, one or more nodes 120 (e.g., physical servers, virtual servers, Internet of Things (IoT) devices, etc.), and a user device 130 (e.g., a personal computer (PC), a laptop, a smartphone, etc.) that are in communication with one another via a network, such as a local area network (LAN), wide area network (WAN), the Internet, or any combination thereof.

The system 100 can include the management node 110 that can manage or otherwise communicate with nodes 120. Examples of the management node 110 or of the nodes 120 can include desktop computers, laptop computers, servers, mobile phones, tablets, etc. The nodes 120 may be edge devices such as Raspberry Pis, sensors, or other resource-constrained, IoT devices. The management node 110 may include a service orchestration platform, such as Kubernetes or OpenShift. As illustrated, the nodes 120 include node 124a and node 124b.

The management node 110 can receive a request 112 to instantiate a service 122 on a node of the nodes 120. The service 122 may be a data service (e.g., a self-contained unit of software functions) or a software application. The management node 110 can evaluate the service 122 as well as the nodes 120 to determine which node on which to deploy the service 122. For instance, the management node 110 can perform energy grading to determine which node on which to deploy the service 122.

In some examples, the management node 110 may determine a usage metric 116 associated with the service 122 using a resource of a node. For instance, the usage metric 116 may include one or more of a central processing unit (CPU) usage, a memory usage, a network utilization, a data size, a data volume, required client connections, network conditions, and processing requirements for the service 122. The usage metric 116 may be indicated in the request 112. For example, the request 112 may include a specification file 114 (e.g., a software bill of materials (SBOM)) associated with the service 122. The specification file 114 can indicate the usage metric 116 for the service 122.

In some embodiments, the management node 110 may also determine an energy metric 118 associated with energy usage of the service 122. For instance, the energy metric 118 may include one or more of an energy consumed per unit of data processed, energy consumed per client connection, or energy consumer per unit of processing requirement. So, in some cases, the energy metric 118 may be based on the usage metric 116. The energy metric 118 may also be indicated in the specification file 114 for the service 122 that is included in the request 112.

In some examples, the management node 110 can determine the energy metric 118 prior to receiving the request 112. For example, the management node 110 may deploy the service 122 on a test set of nodes that include various sets of node capabilities. The test set of nodes can be a standard set of nodes and architectures that have various resource capacities, that are executing various loads, and that experience various environmental conditions. The environmental conditions may include a temperature, a time of day, weather conditions, etc. From the deployment on the test set of nodes, the management node 110 can determine an impact that the service 122 has on energy consumption for a given node. The impact can correspond to the energy metric 118, which may represent a grading score for running the service 122 on a node. So, different nodes may be associated with different grading scores for the energy metric 118 and may account for various environmental conditions.

In some examples, the management node 110 can also determine capabilities 126a-126b for each of the nodes 120. That is, the management node 110 can determine capabilities 126a for the node 124a and capabilities 126b for the node 124b. The capabilities 126a-126b can include resource capacities, energy source access (e.g., battery power, green energy, etc.), currently executing loads, and components connected to the node (e.g. Ethernet, Wi-Fi adapter, Bluetooth adapter, etc.). The management node 110 can poll the nodes 120 to determine the capabilities 126a-126b.

Upon determining the usage metric 116, the energy metric 118, and the capabilities 126a-126b, the management node 110 can determine scores 119 associated with deploying the service 122 on each of the nodes 120. That is, the scores 119 can include a first score associated with deploying the service 122 on the node 124a, a second score associated with deploying the service 122 on the node 124b, and other scores associated with deploying the service 122 on other nodes of the nodes 120. The scores 119 can represent a standardized classification of the energy efficiency of the service 122 for each of the nodes 120. As such, the scores 119 can facilitate selection of a node that results in a highest energy efficiency for a given scenario. For instance, the management node 110 may determine that the first score for the node 124a is higher than the second score for the node 124b, so the management node 110 can deploy the service 122 on the node 124a, which is indicated as being more energy efficient for the service 122 than the node 124b based on the scores 119.

In some examples, the management node 110 may alternatively, or in response to another request for instantiating the service 122, determine that the scores 119 for each of the nodes 120 is lower than a threshold value. The scores 119 being lower than the threshold value may indicate that the executing the service 122 is not energy efficient (e.g., the energy efficiency is below a threshold) for the nodes 120 under the current conditions. So, rather than deploying the service 122 on a node, the management node 110 may pause a deployment of the service 122 based on the scores 119 being lower than the threshold value. At a later time, the scores 119 may be updated as the capabilities 126a-126b of the nodes 120 and environmental conditions change. As such, the management node 110 can determine when the updated score for a node is below the threshold value and then deploy the service 122 on that node.

In some instances, even if the scores 119 are below the threshold value for each of the nodes, the management node 110 may deploy the service 122 if the service 122 is associated with a high priority. For example, if the service 122 performs a security operation or another critical operation, then the management node 110 may determine that the service 122 is a high priority. So, the management node 110 can deploy the service 122 to a node. As an example, the management node 110 can deploy the service 122 on the node with the highest score.

The management node 110 can periodically re-evaluate the deployment of the service 122 on the node 124. For instance, as the capabilities 126a-126b of the nodes 124a-124b and the environmental conditions change, the scores 119 may change. So, if the score for the node 124a is initially higher than the score for the node 124b and the service 122 is deployed to the node 124a, the score for the node 124b may change at some point to be higher than the score for the node 124a. In this case, the management node 110 can migrate the service 122 to the node 124b based on the score for the node 124b being higher than the score for the node 124a.

In some examples, the energy metric 118 may be usable by a developer in updating the service 122. To do so, an indication of the energy metric 118 can be output to the user device 130, which can be associated with the developer. When an update is made to the service 122, such as adding, changing, or removing a feature, the energy metric 118 may be re-determined. For example, the management node 110, or the user device 130 (e.g., a device associated with a developer) may deploy the updated service on the test set of nodes that include various sets of node capabilities. From the deployment on the test set of nodes, the management node 110 or the user device 130 can determine an impact that the updated service has on energy consumption for a given node. So, an updated energy metric can be determined. As a result, a developer may be able to determine whether the update has a positive or negative impact on the energy metric 118. From this, the developer may determine whether or not to maintain the update. If the update has a negative impact on the energy metric 118, the developer may make additional changes to the service 122 that reduce the negative impact before finalizing the updates for the service 122.

While FIG. 1 depicts a specific arrangement of components, other examples can include more components, fewer components, different components, or a different arrangement of the components shown in FIG. 1. For instance, while FIG. 1 only shows two nodes, other examples may include a different number of nodes. Also, any component or combination of components depicted in FIG. 1 can be used to implement the process(es) described herein.

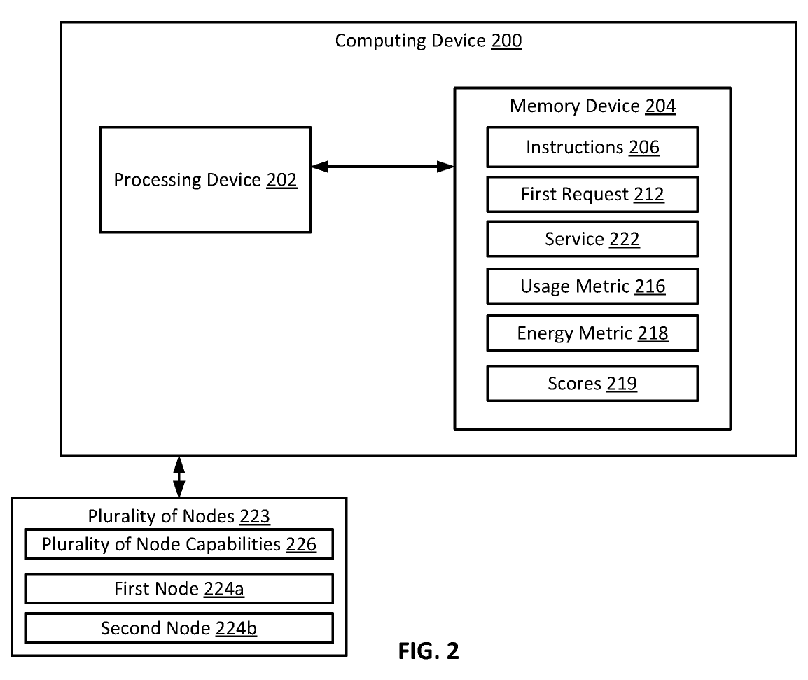

FIG. 2 is a block diagram of an example of a computing device for data service distribution based on energy efficiency according to some examples of the present disclosure. The computing device 200 includes a processing device 202 communicatively coupled to a memory device 204. In some examples, the components of the computing device 200, such as the processing device 202 and the memory device 204, may be part of a same computing device, such as the management node 110 in FIG. 1. In other examples, the processing device 202 and the memory device 204 can be included in separate computing devices that are communicatively coupled.

The processing device 202 can include one processing device or multiple processing devices. Non-limiting examples of the processing device 202 can include a Field-Programmable Gate Array (FPGA), an application-specific integrated circuit (ASIC), and a microprocessor. The processing device 202 can execute instructions 206 stored in the memory device 204 to perform computing operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can include a non-transitory computer-readable medium from which the processing device 202 can read instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the processing device 202 can execute the instructions 206 to perform some or all of the functionality described herein. For example, the processing device 202 can receive a first request 212 to instantiate a service 222 on a node of a plurality of nodes 223. The processing device 202 can determine a usage metric 216 associated with the service 222 using a resource of the node. The processing device 202 can determine an energy metric 218 associated with energy usage of the service 222. The usage metric 216 and the energy metric 218 can be indicated in a specification file associated with the service 222 that is received with the first request 212. The processing device 202 can also determine a plurality of node capabilities 226 for the plurality of nodes 223. The processing device 202 can poll the plurality of nodes 223 to determine the plurality of node capabilities 226. The processing device 202 can determine, based on the usage metric 216, the energy metric 218, and the plurality of node capabilities 226, scores 219 associated with deploying the service 222 on each node of the plurality of nodes 223. The processing device 202 can deploy the service 222 on a first node 224a of the plurality of nodes 223 based on a first score of the scores 219 associated with the first node 224a being higher than a second score of the scores 219 associated with a second node 224b of the plurality of nodes 223. As such, the service 222 is deployed on a node in an energy efficient manner and may be prevented from being deployed on a node that would result in excessive energy consumption.

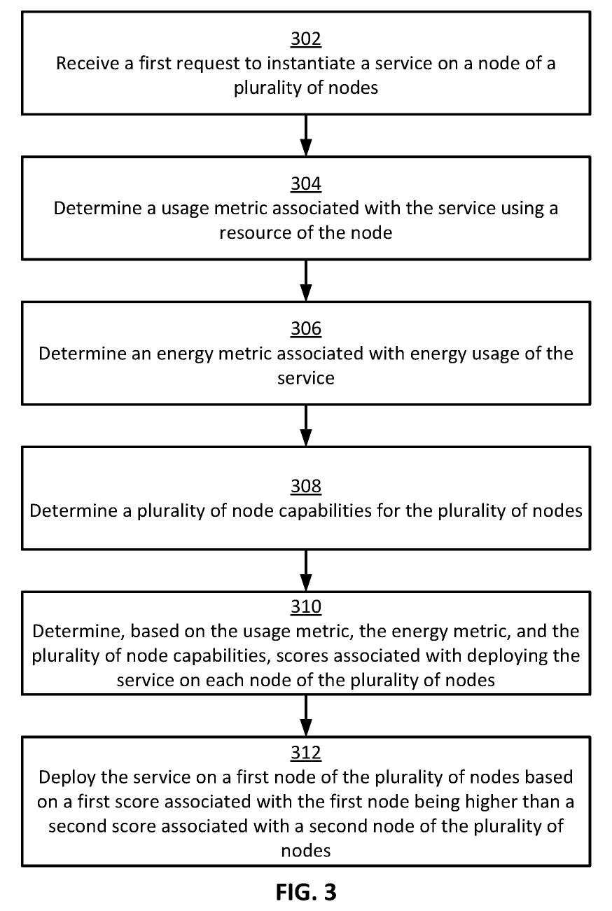

FIG. 3 is a flow chart of an example of a process for data service distribution based on energy efficiency according to some examples of the present disclosure. In some examples, the processing device 202 can implement some or all of the steps shown in FIG. 3. Additionally, in some examples, the processing device 202 can be executing on or in communication with the management node 110 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can receive a first request 212 to instantiate a service 222 on a node of a plurality of nodes 223. The first request 212 may be received from an external user device. The first request 212 may include a specification file 114 associated with the service 222.

At block 304, the processing device 202 can determine a usage metric 216 associated with the service 222 using a resource of the node. The usage metric 216 may include one or more of a CPU usage, a memory usage, a network utilization, a data size, a data volume, required client connections, network conditions, processing requirements, and the like for the service 222. The usage metric 216 can be indicated in the specification file 114.

At block 306, the processing device 202 can determine an energy metric 218 associated with energy usage of the service 222. The energy metric 218 may include one or more of an energy consumed per unit of data processed, energy consumed per client connection, or energy consumer per unit of processing requirement. The energy metric 218 can also be indicated in the specification file 114 for the service 222 that is included in the first request 212. To determine the energy metric 218, the processing device 202 may deploy the service 222 on a test set of nodes that include various sets of node capabilities. The test set of nodes can be a standard set of nodes and architectures that have various resource capacities, that are executing various loads, and that experience various environmental conditions. The energy metric 218 can correspond to an impact of running the service 222 on a given node, which may represent a grading score for running the service 222 on a node.

At block 308, the processing device 202 can determine a plurality of node capabilities 226 for the plurality of nodes 223. The processing device 202 can poll the plurality of nodes 223 to determine the plurality of node capabilities 226. The plurality of node capabilities 226 can include resource capacities, energy source access, currently executing loads, and components connected to a node.

At block 310, the processing device 202 can determine, based on the usage metric 216, the energy metric 218, and the plurality of node capabilities 226, scores 219 associated with deploying the service 222 on each node of the plurality of nodes 223. The scores 219 may be generated by applying weights to the usage metric 216, the energy metric 218, and the plurality of node capabilities 226 for each node of the plurality of nodes 223. A higher score may correspond to a more energy efficient deployment for the service 222. For instance, the scores 219 may be between zero and one-hundred, where scores closer to zero correspond to less energy efficient deployments for the service 222 and scores closer to one-hundred correspond to more energy efficient deployments for the service 222. In addition, the scores 219 may be classified as red, yellow, and green. Red can correspond to a first set of scores that correspond to low energy efficient scores (e.g., scores between zero and thirty), yellow can correspond to a second set of scores that correspond to medium energy efficient scores (e.g., scores between thirty and seventy), and green can correspond to a third set of scores that correspond to high energy efficient scores (e.g., scores between seventy and one-hundred).

At block 312, the processing device 202 can deploy the service 222 on a first node 224a of the plurality of nodes 223 based on a first score associated with the first node 224a being higher than a second score associated with a second node 224b of the plurality of nodes 223. For instance, if the first node 224a is associated with a score of sixty-five and the second node 224b is associated with a score of fifty, the processing device 202 can deploy the service 222 on the first node 224a since the higher score indicates the service 222 as being more energy efficient for the first node 224a than for the second node 224b. Over time, the scores 219 may change for the plurality of nodes 223, so the first score for the first node 224a may become lower than the second score for the second node 224b. At that point, the processing device 202 may migrate the service 222 to the second node 224b. In addition, if both of the first score and the second score are below a threshold (e.g., seventy), the processing device 202 may pause or forgo deployment of the service 222 on the first node 224a and the second node 224b. But, if the first request 212 indicates a high priority for the instantiation of the service 222, the processing device 202 can select a node of the plurality of nodes 223 that has a highest score regardless of whether the score meets the threshold or not. Due to the consideration of energy efficiency and the dynamic deployment of services, energy can be conserved and overall performance of the plurality of nodes 223 can be improved.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device including instructions that are executable by the processing device for causing the processing device to perform operations comprising:
receiving a first request to instantiate a service on a node of a plurality of nodes;
determining a usage metric associated with the service using a resource of the node;
determining an energy metric associated with energy usage of the service;
determining a plurality of node capabilities for the plurality of nodes;
determining, based on the usage metric, the energy metric, and the plurality of node capabilities, scores associated with deploying the service on each node of the plurality of nodes; and
deploying the service on a first node of the plurality of nodes based on a first score associated with the first node being higher than a second score associated with a second node of the plurality of nodes.

2. The system of claim 1, wherein the operations further comprise:
deploying, prior to receiving the first request, the service on a test set of nodes comprising different sets of node capabilities; and
determining the energy metric based on deploying the service on the test set of nodes.

3. The system of claim 2, wherein the first request includes a specification file associated with the service, and wherein the specification file indicates the usage metric and the energy metric.

4. The system of claim 1, wherein the operations further comprise:
receiving a second request to instantiate the service on the node of the plurality of nodes;
determining the scores associated with deploying the service on each node of the plurality of nodes based on the usage metric, the energy metric, and the plurality of node capabilities for the plurality of nodes; and
pausing a deployment of the service based on each score of the scores being lower than a threshold value.

5. The system of claim 4, wherein the operations further comprise:
determining updated scores for the plurality of nodes subsequent to a period of time passing after pausing the deployment of the service; and
deploying the service on a third node of the plurality of nodes based on determining that an updated score associated with the third node is greater than the threshold value.

6. The system of claim 1, wherein the operations further comprise:
outputting an indication of the energy metric to a user device, wherein the energy metric is configured to be used for updating the service.

7. The system of claim 1, wherein the operations further comprise:
determining, subsequent to a period of time passing after deploying the service on the first node, that the second score is higher than the first score; and
migrating the service to the second node based on the second score being higher than the first score.

8. A method comprising:
receiving a first request to instantiate a service on a node of a plurality of nodes;
determining a usage metric associated with the service using a resource of the node;
determining an energy metric associated with energy usage of the service;
determining a plurality of node capabilities for the plurality of nodes;
determining, based on the usage metric, the energy metric, and the plurality of node capabilities, scores associated with deploying the service on each node of the plurality of nodes; and
deploying the service on a first node of the plurality of nodes based on a first score associated with the first node being higher than a second score associated with a second node of the plurality of nodes.

9. The method of claim 8, further comprising:
deploying, prior to receiving the first request, the service on a test set of nodes comprising different sets of node capabilities; and
determining the energy metric based on deploying the service on the test set of nodes.

10. The method of claim 9, wherein the first request includes a specification file associated with the service, and wherein the specification file indicates the usage metric and the energy metric.

11. The method of claim 8, further comprising:
receiving a second request to instantiate the service on the node of the plurality of nodes;
determining the scores associated with deploying the service on each node of the plurality of nodes based on the usage metric, the energy metric, and the plurality of node capabilities for the plurality of nodes; and
pausing a deployment of the service based on each score of the scores being lower than a threshold value.

12. The method of claim 11, further comprising:
determining updated scores for the plurality of nodes subsequent to a period of time passing after pausing the deployment of the service; and
deploying the service on a third node of the plurality of nodes based on determining that an updated score associated with the third node is greater than the threshold value.

13. The method of claim 8, further comprising:
outputting an indication of the energy metric to a user device, wherein the energy metric is configured to be used for updating the service.

14. The method of claim 8, further comprising:
determining, subsequent to a period of time passing after deploying the service on the first node, that the second score is higher than the first score; and
migrating the service to the second node based on the second score being higher than the first score.

15. A non-transitory computer-readable medium comprising program code that is executable by a processor for causing the processor to perform operations including:
receiving a first request to instantiate a service on a node of a plurality of nodes;
determining a usage metric associated with the service using a resource of the node;
determining an energy metric associated with energy usage of the service;
determining a plurality of node capabilities for the plurality of nodes;
determining, based on the usage metric, the energy metric, and the plurality of node capabilities, scores associated with deploying the service on each node of the plurality of nodes; and
deploying the service on a first node of the plurality of nodes based on a first score associated with the first node being higher than a second score associated with a second node of the plurality of nodes.

16. The non-transitory computer-readable medium of claim 15, further comprising:
deploying, prior to receiving the first request, the service on a test set of nodes comprising different sets of node capabilities; and
determining the energy metric based on deploying the service on the test set of nodes.

17. The non-transitory computer-readable medium of claim 15, wherein the operations further comprise:
receiving a second request to instantiate the service on the node of the plurality of nodes;
determining the scores associated with deploying the service on each node of the plurality of nodes based on the usage metric, the energy metric, and the plurality of node capabilities for the plurality of nodes; and
pausing a deployment of the service based on each score of the scores being lower than a threshold value.

18. The non-transitory computer-readable medium of claim 17, wherein the operations further comprise:
determining updated scores for the plurality of nodes subsequent to a period of time passing after pausing the deployment of the service; and
deploying the service on a third node of the plurality of nodes based on determining that an updated score associated with the third node is greater than the threshold value.

19. The non-transitory computer-readable medium of claim 15, wherein the operations further comprise:
outputting an indication of the energy metric to a user device, wherein the energy metric is configured to be used for updating the service.

20. The non-transitory computer-readable medium of claim 15, wherein the operations further comprise:
determining, subsequent to a period of time passing after deploying the service on the first node, that the second score is higher than the first score; and
migrating the service to the second node based on the second score being higher than the first score.
